(19) United States
(12) Patent Application Publication
(10) Pub. No.: US 2018/0081129 A1
(43) Pub. Date: Mar. 22, 2018

(54) PULL-OUT TAB OF OPTICAL CONNECTOR PLUG

(71) Applicant: SANWA DENKI KOGYO CO., LTD., Tokyo (JP)

(72) Inventors: Tomoaki KAGA, Tokyo (JP); Takashi SATO, Tokyo (JP)

(21) Appl. No.: 15/702,795

(22) Filed: Sep. 13, 2017

(30) Foreign Application Priority Data
Sep. 20, 2016 (JP) 2016-182707

(51) Int. Cl. G02B 6/38

(52) U.S. Cl. CPC G02B 6/3898; G02B 6/3887; G02B 6/3885; G02B 6/3893

(57) ABSTRACT

The invention prevents the other adjacent pull-out tab from easily entering into a portion between the pull-out tab and the optical fiber cord or the optical fiber tape core wire, by setting a structure for gripping the optical fiber cord or the optical fiber tape core wire in the last end of the pull-out tab. In a pull-out tab of an optical connector plug structured such that the optical connector plug is engaged with and disengaged from an adapter by the pull-out tab which is detachably installed to an operation portion of the optical connector plug, the pull-out tab is provided with a retainer mechanism which is arranged in a tab leading end for installing to the operation portion of the optical connector plug, and a support portion which is arranged in the last end of the tab for gripping an optical cord.

### TECHNICAL FIELD

The present invention relates to an optical connector plug which is used when an optical fiber is connected, and also relates to a pull-out tab of the optical connector plug which is used for improving an operability of installing to and pulling out of an adapter.

### BACKGROUND ART

Conventionally, this kind of optical connector plug is integrally provided on an outer peripheral surface of a plug housing thereof with a latch for engaging with the adapter and releasing the engagement. The latch is extended so as to come away from an outer surface of the plug housing little by little toward a rear end portion from a leading end portion of the plug housing. In the case that the optical connector plug is installed to the adapter, the latch slightly protrudes to a rear end of the adapter. Further, when the optical connector plug is pulled out of the adapter, the engagement is released by directly pushing down the latch with a fingertip.

Further, this kind of optical connector plug includes a type which is additionally provided in a main body frame side with a latch release member which is engaged with a rear end portion of the latch, and releases the engagement with the adapter by indirectly pushing down the latch via the latch release member.

For example, as disclosed in patent document 1, there exists a pull-out tab of a push-pull type optical connector plug structured such that a slider is provided as a latch released member which is installed so as to be movable in a controlled range in an axial direction of a plug main body by both stoppers including one stopper arranged in a front side in both sides of the plug main body and the other stopper arranged in a rear side with a predetermined distance, a release piece of a release lever is pushed down with a taper surface of the slider by moving the slider in a pull-out direction at a time of pulling out of the adapter, an engagement between a locking piece and the adapter is released, the plug main body and the release lever return to an initial position on the basis of an elastic force of the release lever at the same time that the slider is pulled out of the adapter, an operation portion for gripping at the operating time is provided at least above and below a rearward end of the slider, the pull-out tab which can operate the slider in a rearward optical cord side is detachably installed to the operation portion of the slider, and a C-ring shaped hood for gripping the optical cord is formed approximately at the center of a lower surface of the pull-out tab.

Further, as disclosed in patent document 2, there exists a technique of a push-pull type optical connector assembly structured such that a latch release member arranged so as to be movable in an axial direction is provided within a housing which retains an optical connector plug, a latch can be engaged with an adapter by moving a housing to the adapter side and inserting the optical connector plug into the adapter, and the engagement with the adapter can be released by pressing a rear end portion of the latch on the basis of a relative movement of the latch release member to a forward side in relation to the housing achieved by moving the housing in a reverse direction.

In the meanwhile, a multicore batch connector which can connects an optical fiber efficiently with a high density has been conventionally used in conjunction with development of a high-density multicore cable for connecting SM type optical fiber single core wires in a lump and with low loss. This connecting system is a system of positioning and fitting ferrules which position and fix multicore optical fibers with two guide pins, and this connector is called as an MT connector since the connector can be applied to a mechanical high-speed switching in addition to the batch connection of the optical fiber tape core wires, and has been put to practical use in recent years as a connector for connecting 4-core, 8-core and 12-core optical fiber tapes of an access series multicore cable.

On the other hand, in recent years, there has been put to practical use an MPO type optical connector which can be easily attached and detached with a push-pull operation, as a batch connector for further multicores, such as 24 cores and 72 cores for connecting an ultra multicore cable.

### CITATION LIST

### Patent Documents

Patent Document 1: Japanese Patent No. 5154985
Patent Document 2: Japanese Unexamined Patent Publication No. 2001-141961

### SUMMARY OF THE INVENTION

### Problem to be Solved by the Invention

However, in the MPO type optical connector mentioned above and a so-called push-pull type optical connector plug shown in patent document 2, a patch cord (a patched cord) to which a pull-out tab in patent document 1 mentioned above is installed is formed, and in the case that a lot of connector plugs are bundled like in a high density mounting of the optical connectors, there is generated a phenomenon that the pull-out tab of the other adjacent optical connector plug enters into the portion between the pull-out tab and the optical fiber cord or the optical fiber tape core wire so as to intertwine is generated and there is a problem of being hard to handle.

Conventionally, in order to solve the problem mentioned above, a technique using a hook member is proposed as shown in patent document 1. However, in the present technique, since a C-ring shaped hook 102A is formed approximately at the center of a lower surface of a pull-out tab 101A as shown in FIGS. 9A and 9B, there has been frequently generated a phenomenon that a pull-out tab 101A is installed to an optical connector plug 100A, and a rear end portion side of a pull-out tab 101B in a rear side of a hook 102B formed approximately at the center of a lower surface of the other adjacent optical connector plug 1008 easily enters into a gap between a rear end portion of the pull-out tab 101A in a rear side of the hook 102A and an optical fiber cord 103A so as to intertwine.

Consequently, the present invention is made by taking into consideration the conventionally existing various circumstances as mentioned above, and an object of the present invention is to provide a pull-out tab of an optical connector plug which prevents the other adjacent pull-out tab from easily entering into a portion between the pull-out tab and the optical fiber cord or the optical fiber tape core wire, by setting a structure for gripping the optical fiber cord or the optical fiber tape core wire in the last end of the pull-out tab.

### Means for Solving Problem

In order to achieve the object mentioned above, according to the present invention, there is provided a pull-out tab of an optical connector plug structured such that the optical connector plug is engaged with and disengaged from an adapter by the pull-out tab which is detachably installed to an operation portion of the optical connector plug, wherein the pull-out tab is provided with a retainer mechanism which is arranged in a tab leading end for installing to the operation portion of the optical connector plug, and a support portion which is arranged in the last end of the tab for gripping an optical cord.

The retainer mechanism is formed by a set hole which is provided in a tab leading end for installing to an operation portion of an LC type single core optical connector plug, and the support portion is formed as a downward C-ring shaped hook in the last end of a lower surface of a grip portion which is extended to a rear side of the tab for gripping the optical cord.

The retainer mechanism is formed as a pair of set holes which are provided in a tab leading end for respectively installing to a pair of operation portions of a pair of LC type single core optical connector plugs, and the support portion is formed as an approximately ring shaped hook in the last end of a lower surface of a grip portion which is extended to a rear side of the tab for gripping a pair of optical cords.

The retainer mechanism is formed as a protruding piece portion which is formed into a T-shaped form in a plan view and is provided in a tab leading end for installing over a pair of right and left locking concave portions of an LC type double core optical connector plug, and the support portion is formed as a transversely L-shaped catch portion in the last end of a side surface of a grip portion which is extended to a rear side of the tab for mounting the optical cord.

The retainer mechanism is provided with a transversely C-shaped frame which is arranged in a tab leading end for installing to a coupling which constructs an operation portion of an optical connector plug according to an MPO type push-pull system from a lateral side, and a support portion which catches an optical fiber tape core wire alternately up and down by a rear projection which is protruded transversely in the last end of a side surface of a grip portion which is extended to a rear side of the tab and an intermediate projection which is protruded transversely at the midpoint of a side surface of the grip portion so as to be slidable and be capable of gripping.

### Effect of the Invention

According to the present invention, it is possible to prevent the other adjacent pull-out tab from easily entering into the portion between the pull-out tab and the optical fiber cord or the optical fiber tape core wire, by setting the structure for gripping the optical fiber cord or the optical fiber tape core wire in the last end of the pull-out tab. Further, it is possible to provide the pull-out tab of the optical connector plug which can correspond to any of an LC type single core, an LC type double core, an MPO type and an SC type of the optical connector plugs.

More specifically, according to the present invention, in the pull-out tab of the optical connector plug structured such that the optical connector plug is engaged with and disengaged from the adapter by the pull-out tab which is detachably installed to the operation portion of the optical connector plug, the pull-out tab is provided with the retainer mechanism which is arranged in the tab leading end for installing to the operation portion of the optical connector plug, and the support portion which is arranged in the last end of the tab for gripping an optical cord. As a result, it is possible to previously prevent the other adjacent pull-out tab from entering to and intertwining in the portion between the pull-out tab and the optical fiber cord, by the support portion which grips the optical fiber cord in the rear end of the pull-out tab.

The retainer mechanism is formed by the set hole which is provided in the tab leading end for installing to the operation portion of the LC type single core optical connector plug, and the support portion is formed as the downward C-ring shaped hook in the last end of the lower surface of the grip portion which is extended to the rear side of the tab for gripping the optical cord. As a result, the pull-out tab can be easily attached to and detached from the operation portion of the slider in the LC type single core optical connector plug and the optical cord.

The retainer mechanism is formed as the pair of set holes which are provided in the tab leading end for respectively installing to the pair of operation portions of the pair of LC type single core optical connector plugs, and the support portion is formed as the approximately ring shaped hook in the last end of the lower surface of the grip portion which is extended to the rear side of the tab for gripping the pair of optical cords. As a result, the pull-out tab can be easily attached to and detached from the pair of operation portions of the sliders in the pair of LC type single core optical connector plugs and the pair of optical cords.

The retainer mechanism is formed as the protruding piece portion which is formed into the T-shaped form in the plan view and is provided in the tab leading end for installing over the pair of right and left locking concave portions of the LC type double core optical connector plug, and the support portion is formed as the transversely L-shaped catch portion in the last end of the side surface of the grip portion which is extended to the rear side of the tab for mounting the optical cord. As a result, the pull-out tab can be easily attached to and detached from the locking concave portions in the slider upper surface of the LC type double core optical connector plug and the optical cord.

The retainer mechanism is provided with the transversely C-shaped frame which is arranged in the tab leading end for installing to the coupling which constructs the operation portion of the optical connector plug according to the MPO type push-pull system from the lateral side, and the support portion which catches the optical fiber tape core wire alternately up and down by the rear projection which is protruded transversely in the last end of the side surface of the grip portion which is extended to the rear side of the tab and the intermediate projection which is protruded transversely at the midpoint of the side surface of the grip portion so as to be slidable and be capable of gripping. As a result, it is possible to previously prevent the adjacent pull-out tab from entering into and intertwining in the portion between the pull-out tab and the optical fiber taper core wire, by the support portion which grips the optical fiber taper core wire in the rear end of the pull-out tab. Further, the pull-out tab can be easily attached to and detached from the coupling of the optical connector plug and the optical fiber taper core wire according to the MPO type push-pull system.

### BRIEF DESCRIPTION OF DRAWINGS

FIGS. 1A and 1B show an example which uses a pull-out tab according to an embodiment for carrying out the present invention in an LC type single core optical connector plug, in which FIG. 1A is a perspective view of a state before the pull-out tab is installed to an operation portion, and FIG. 1B is a perspective view of a state after the pull-out tab is installed to the operation portion;

FIGS. 2A and 2B show an example which uses the pull-out tab in the LC type single core optical connector plug in the same manner, in which FIG. 2A is a cross sectional view of the state before the pull-out tab is installed to the operation portion, and FIG. 2B is a cross sectional view of the state after the pull-out tab is installed to the operation portion;

FIGS. 3A and 3B show an example which uses the pull-out tab in a pair of LC type single core optical connector plugs in the same manner, in which FIG. 3A is a perspective view of a state before the pull-out tab is installed to the operation portion, and FIG. 3B is a perspective view of a state after the pull-out tab is installed to the operation portion;

FIGS. 4A and 4B show an example which uses the pull-out tab in an LC type double core optical connector plug in the same manner, in which FIG. 4A is a perspective view of a state before the pull-out tab is installed to the operation portion, and FIG. 4B is a perspective view of a state after the pull-out tab is installed to the operation portion;

FIGS. 5A and 5B show a part of the LC type double core optical connector plug in the same manner, in which FIG. 5A is an exploded perspective view of a slider and an upper holder portion constructing a retention body, and FIG. 5B is a step diagram describing a motion of the slider after the slider and the upper holder are assembled;

FIGS. 6A and 6B show an example which uses the pull-out tab in the LC type double core optical connector plug in the same manner, in which FIG. 6A is a cross sectional view of the state before the pull-out tab is installed to the operation portion, and FIG. 6B is a cross sectional view of the state after the pull-out tab is installed to the operation portion;

FIGS. 7A and 7B show an example which uses the pull-out tab in an MPO type optical connector plug in the same manner, in which FIG. 7A is a perspective view of the pull-out tab, and FIG. 7B is a perspective view of the optical connector plug;

FIGS. 8A and 8B show an example which uses the pull-out tab in the MPO type optical connector plug in the same manner, in which FIG. 8A is a perspective view of a state before the pull-out tab is installed to the operation portion, and FIG. 8B is a perspective view of a state after an optical tape core wire is installed to a support portion; and

FIGS. 9A and 9B show a conventional example, in which FIG. 9A is a perspective view showing an intertwining state between the pull-out tabs in the conventional example, and FIG. 9B is a vertical cross sectional view showing an example of a conventional adapter.

### MODES FOR CARRYING OUT THE INVENTION

A description will be in detail given below of an embodiment of a pull-out tab of an optical connector plug according to the present invention with reference to the accompanying drawings.

<Structure of LC Type Single Core Optical Connector Plug>

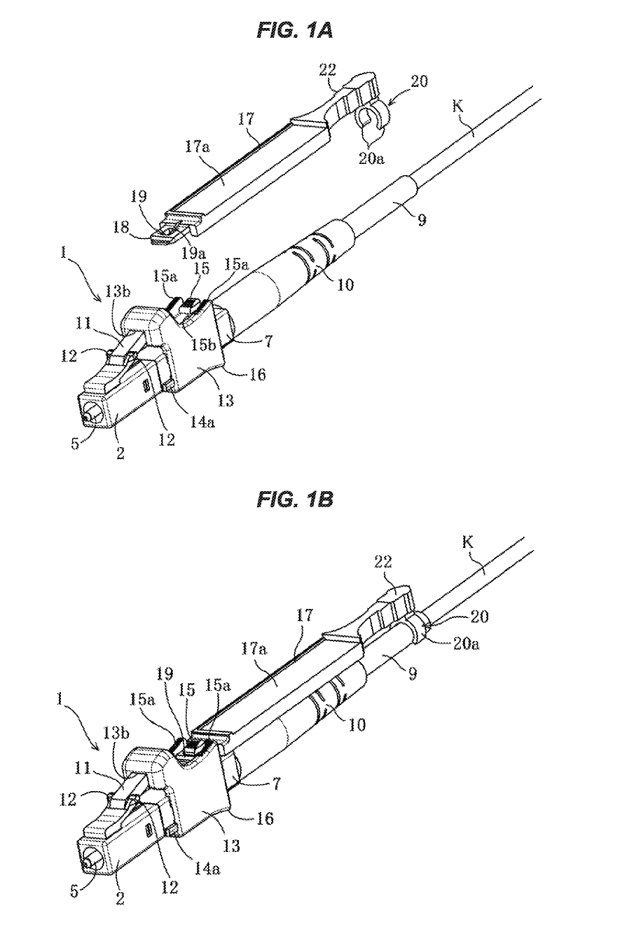

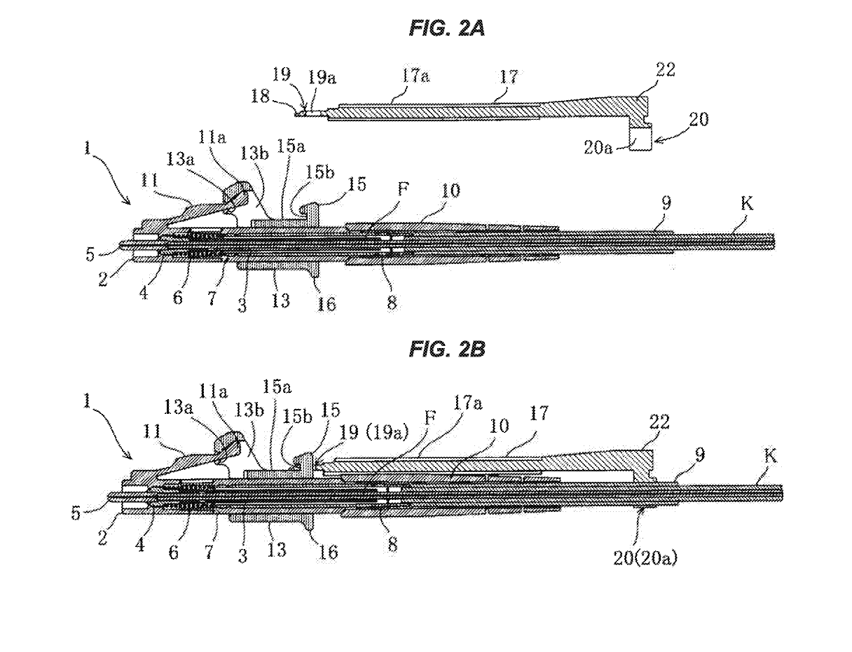

The optical connector plug according to the present invention is constructed, for example, by an LC type single core plug main body 1. The plug main body 1 is provided with a coupling sleeve 2 which is made of plastics having a comparatively high strength, a ferrule 5 which is constructed by a ferrule tube 3 and a ferrule frame 4 within the coupling sleeve 2, a spring 6 which is installed to an outer periphery of a rear end portion of the ferrule frame 4 and retains the ferrule 5 within the coupling sleeve 2 so as to energize the ferrule 5 forward in an axial direction, a main body frame 7 which is fitted to the rear end portion of the ferrule frame 4 via the spring 6 and is made of plastics, a heat shrinkable tube 9 which protects an optical fiber core wire F in a rear side of the main body frame 7 and is provided with a caulking ring 8 for preventing disconnection due to deformation, and a boot 10 which is outward fitted to the rear side of the main body frame 7 via the caulking ring 8 and covers a part of the heat shrinkable tube 9, as shown in FIGS. 1A, 1B, 2A and 2B.

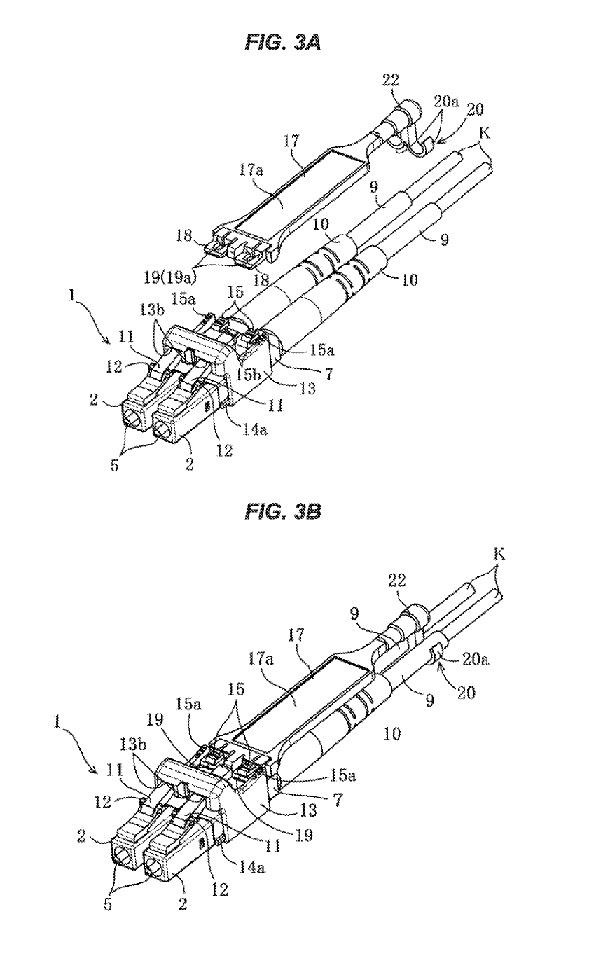

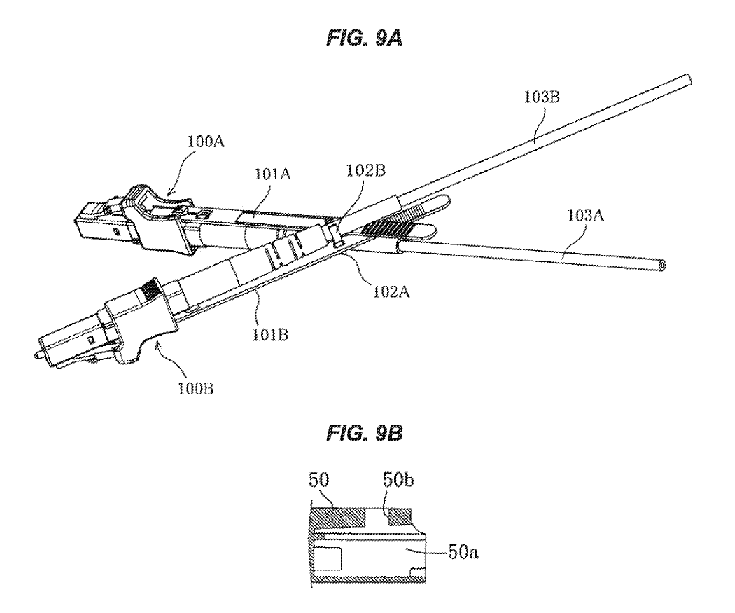

Further, as shown in FIGS. 1A, 1B, 3A and 3B, an outer peripheral surface of the coupling sleeve 2 is provided with a locking piece 12 for engaging with an adapter 50 shown in FIG. 9B and releasing the engagement approximately at the center of both side surfaces in a width direction, and is provided integrally in an upper portion of the coupling sleeve 2 with a release lever 11 having a pair of release pieces 11a protruding transversely in relation to an axial direction at right and left symmetrical positions of a rear end thereof, as shown in FIGS. 2A and 2B. The release lever 11 is extended diagonally in one surface in a longitudinal direction of the coupling sleeve 2 of the plug main body 1 so as to come away from an outer surface of the coupling sleeve 2 little by little from a leading end portion toward a rear end portion, and a pair of right and left release pieces 11a in the rear end portion thereof form a complementary relationship to taper surfaces 13a which are provided at right and left symmetrical positions in an inner side of an opening portion 13b of the slider 13 so as to come into contact with the taper surfaces 13a as in detail mentioned later.

More specifically, the housing shaped slider 13 is installed to an outer peripheral surface of the main body frame 7, and a movement in an axial direction of the slider 13 is controlled by stoppers 14a which are provided in a front side in both side surfaces of the main body frame 7 and stoppers (not shown) which are provided in a rear side with a predetermined distance, as shown in FIGS. 1A and 1B and FIGS. 3A and 3B. The slider 13 is upraised somewhat forward diagonally in a front end side of an upper surface, as shown in FIGS. 1A, 1B, 2A and 2B, an opening portion 13b formed approximately into a C-shaped arch so as to form a space where the release lever 11 can displace approximately in a perpendicular direction in relation to the axial direction is provided to pass through in a back-and-forth direction in an upper side in which the upraised inner side faces to the main body frame 7, and right and left symmetrical portions in the inner side of the opening portion 13b forms a taper surface 13a which is inclined toward a leading end side of the main body frame 7. A pair of right and left release pieces 11a in the inclined rear end portion of the release lever 11 are engaged with the taper surface 13a.

Further, as shown in FIGS. 1A, 1B, 2A, 2B, 3A and 3B, a pair of right and left grip portions 15a are provided in an extending manner in a rear side of the opening portion 13b of the slider 13, the grip portions 15a being formed to be widen toward the end from the upraised position toward the rear side, and a rectangular convex shaped operation portion 15 for gripping with a fingertip when operating the slider 13 is provided between the right and left grip portions 15a. A knurl for preventing slip is formed on upper surfaces of the operation portion 15 and the grip portion 15a. In the operation portion 15, a head portion corresponding to an upper portion is wide, and a constricted portion 15b is formed in front and side surfaces in a root portion corresponding to a lower portion. Further, a pull-out tab 17 mentioned later is installed to the operation portion 15 via a set hole 19a of the protruding piece portion 18 which serves as the retainer mechanism 19 so as to be caught on and locked to a front side of the constricted portion 15b (refer to FIGS. 1B, 2B and 3B). In this connection, since both right and left side edges of the pull-out tab 17 are pinched by a pair of right and left grip portions 15a at this time, the rotation of the pull-out tab 17 is controlled. Further, a lower operation portion 16 is formed in a rear end portion of a lower surface of the slider 13 in correspondence to the operation portion 15, as shown in FIGS. 1A, 1B, 2A and 2B, the lower operation portion 16 being formed into a projection shape which has an approximately skirt-shaped cross section with somewhat small incline.

When the plug main body 1 is installed to the adapter 50 shown in FIG. 9B, the plug main body 1 and the adapter 50 are engaged by the locking piece 12 of the release lever 11. More specifically, the release lever 11 is pressed when the plug main body 1 is installed to the adapter 50 since the locking piece 12 is inserted into a plug insertion hole 50a of the adapter 50, and is installed while displacing downward together with the locking piece 12. Further, since the locking piece 12 is elastically locked to a locking groove 50b which is formed in an upper side of the adapter 50, the locking piece 12 and the adapter 50 can be engaged. More specifically, the locking piece 12 and the release lever 11 are formed in the front end side of the upper surface of the coupling sleeve 2, one stopper 14a is formed in a lower edge portion in a front end side of each of both the side surfaces of the main body frame 7, and the other stopper (not shown) is formed in a center portion in a rear end side of each of both the side surfaces of the main body frame 7. When installing to the adapter 50, the plug main body 1 is indirectly operated via the slider 13. In this case, when moving the slider 13 in a direction of the adapter 50, the plug main body 1 can be installed to the adapter 50 on the basis of the movement control by the stopper 14a, and the locking piece 12 and the release lever 11 enter into the locking groove 50b after displacing to a downward side of the plug insertion hole 50a of the adapter 50, so that the locking piece 12 and the adapter 50 are engaged.

On the other hand, when the plug main body 1 is pulled out of the adapter 50, the engagement between the locking piece 12 and the adapter 50 is released by pushing down the release piece 11a of the release lever 11 by the taper surface 13a of the slider 13 on the basis of the movement of the slider 13 in the pull-out direction. At this time, since the position of the stopper in the rear portion side is at least in the rear side of the position where the engagement between the locking piece 12 and the adapter 50 is disconnected, on the basis of the movement of the slider 13, the movement of the slider 13 is controlled when operating to move the slider 13 in the rearward pull-out direction, and the force for activating the plug main body 1 rearward is generated. Therefore, the plug main body 1 can be pulled out of the adapter 50. At this time, the slider 13 returns to the initial position on the basis of the elastic force of the release lever 11 at the same time when the slider 13 is pulled out of the adapter 50. On the other hand, in the case that the slider 13 is operated to be moved in the forward installing direction, the movement of the slider 13 is controlled by the stopper 14a at the forward position, and the force for activating the plug main body 1 forward is generated. Therefore, the plug main body 1 can be installed to the adapter 50.

<Structure of Pull-Out Tab>

A description will be given of a specific structure of the pull-out tab which is the feature of the present invention, on the assumption that the above LC type single core optical connector plug is a basic structure.

As shown in FIGS. 1A, 1B, 2A and 2B, the operation portion 15 of the slider 13 is structured such that a pull-out tab 17 can be installed to the operation portion 15, the pull-out tab 17 being capable of operating the slider 13 in a rearward optical cord K side (a side of a position of the heat shrinkable tube 9) and being formed into a band plate shape. The slider 13 moves in the pull-out direction in an interlocking manner by moving the pull-out tab 17 in the pull-out direction (the rearward optical cord K side). More specifically, a protruding piece portion 18 having a narrower width than the pull-out tab 17 and formed into a rectangular flat plate is formed in a front end side of the pull-out tab 17, and a set hole 19a is open to the center of the protruding piece portion 18, the set hole 19a constructing a retainer mechanism 19 for inserting a head portion of the operation portion 15 of the slider 13 and formed into a rectangular opening shape. The constricted portion 15b in the lower side of the head portion of the operation portion 15 is structured such that an inner edge forward side of the set hole 19a is locked to the constricted portion 15b so as to prevent an accidental pull-out.

Further, a grip portion 22 having a narrower width than the pull-out tab 17 is formed in a rear end side of the pull-out tab 17. The grip portion 22 is formed into an approximately oval shape in a plan view from a rear end edge of the pull-out tab 17 via a curved constricted portion, and a knurl is formed in a side surface thereof in such a manner as to be operable while being held by a hand. Further, a hook 20a is formed in the last end of a lower surface of the grip portion 22, the hook 20a constructing the support portion 20 and having a downward C-ring shape (having a C-ring with downward oriented cut). The pull-out tab 17 itself can be attached to the heat shrinkable tube 9 following the curve of the heat shrinkable tube 9 which covers the optical cord K. More specifically, when the heat shrinkable tube 9 is inserted to the cut of the C-ring shaped hook 20a, the heat shrinkable tube 9 is forcibly fitted while the cut is somewhat expanded, the cut is constricted to the original state on the basis of an elastic return of the C-ring shaped hook 20a after the fitting, and the heat shrinkable tube 9 is held by the hook 20a, and comes to a state in which the heat shrinkable tube 9 is slidably supported. The pull-out tab 17 may be formed longer than the illustrated one, and the hook 20a may be retained to the optical cord K in the rear side of the heat shrinkable tube 9. Further, a label sticking area 17a for sticking a label clearly describing the kind of the plug main body 1 to be subjected is provided approximately at the center of the upper surface of the pull-out tab 17.

Next, a description will be given in detail of an example of use of the pull-out tab of the optical connector plug according to the present invention which is constructed as mentioned above.

When the plug main body 1 is installed to the adapter 50, the set hole 19a constructing the retainer mechanism 19 of the pull-out tab 17 is installed to the operation portion 15 of the slider 13 and the heat shrinkable tube 9 is inserted into the cut of the C-ring shaped hook 20a constructing the support portion 20, as shown in FIGS. 1 and 2. Further, the grip portion 22 of the pull-out tab 17 is moved in an adapter installing direction with a fingertip. At this time, the movement of the operation portion 15 is controlled by the stopper 14a at the forward position, and the plug main body 1 moves into the adapter 50. At the same time, the locking piece 12 enters into the locking groove 50b after displacing to the lower side of the plug insertion hole 50a of the adapter 50, and the locking piece 12 and the adapter 50 are engaged. As a result, the plug main body 1 is installed to the adapter 50.

On the other hand, when the plug main body 1 is pulled out of the adapter 50, the slider 13 is moved in the same pull-out direction in an interlocking manner by moving the grip portion 22 of the pull-out tab 17 in the pull-out direction with the fingertip. At this time, the locking piece 12 is detached from the locking groove 50b of the adapter 50 by pressing down the release piece 11a in the rear end portion of the release lever 11 by the taper surface 13a of the slider 13. As a result, the engagement between the locking piece 12 and the adapter 50 is released. Further, in the case that the slider 13 moves in the pull-out direction via the grip portion 22, the slider 13 is controlled its movement by the stopper in the rear portion side, and the plug main body 1 can be pulled out of the adapter 50. Further, at the same time when the slider 13 is pulled out of the adapter 50, the slider 13 itself is returned to the original position on the basis of the elastic force of the release lever 11. As described above, in the present example, it is possible to previously prevent the adjacent pull-out tab 17 from entering into and intertwining in the portion between the pull-out tab 17 and the optical cord K.

<Structure of Pull-Out Tab of a Pair of LC Type Single Core Optical Connector Plugs>

Next, a description will be given of a structure of a pull-out tab which is installed to a single slider for simultaneously operating a pair of LC type single core optical connector plugs. Since the structure of one LC type single core optical connector plug is the same as that of the present embodiment mentioned above, a detailed description thereof will be omitted.

As shown in FIGS. 3A and 3B, the opening portion 13b of the slider 13 is formed to be a pair of right and left opening portions, and the plug main bodies 1 of two LC type single core optical connector plugs are respectively inserted thereto. Further, a pair of right and left operation portions 15 are provided in the slider 13 in correspondence to two plug main bodies 1, and the retainer mechanism 19 is formed to be the set holes 19a which are opened to the respective center portions of a pair of right and left protruding piece portions 18 provided in the tab leading end of the pull-out tab 17 for respectively engaging with the operation portions 15. Further, the support portion 20 is formed to be the hook 20a approximately having a double-ring shape in the last end of a lower surface of the grip portion 22 which is extended to be enlarged in its diameter little by little and is formed approximately into a circular column shape to the rear side of the pull-out tab 17 via the curved constricted portion for slidably gripping a pair of right and left optical cords K. The approximately double-ring shaped hook 20a is, for example, a hook 20a having a shape obtained by bonding respective end portions of a pair of C-shaped ring having the upward oriented cuts, or a shape obtained by bonding approximately J-shaped band pieces having mutually opposed cut portions.

As a result, when a pair of right and left plug main bodies 1 are pulled out simultaneously of the adapter 50, the slider 13 is moved in the same pull-out direction in an interlocking manner by moving the grip portion 22 of the pull-out tab 17 in the pull-out direction with the fingertip. At this time, since the release pieces 11a in the rear end portions of the right and left release levers 11 are simultaneously pushed down by the taper surfaces 13a of the slider 13, the engagement between each of the locking pieces 12 of the right and left release levers 11 and the locking groove 50b of the adapter 50 is released. Further, when the slider 13 moves in the pull-out direction via the grip portion 22, the movement is controlled by the stopper in the rear side, and the plug main body 1 can be pulled out of the adapter 50. As described above, in the present example, it is possible to previously prevent the other adjacent pull-out tab 17 from entering into and intertwining in the portion between the pull-out tab 17 and a pair of optical cords K.

<Structure of Pull-Out Tab of LC Type Double Core Optical Connector Plug>

Next, a description will be given of a specific structure of the pull-out tab which is the feature of the present invention on the assumption that the LC type double core optical connector plug is the basic structure. Since the structures of the coupling sleeve 2 and the release lever 11 are the same as those of the present embodiment mentioned above, a detailed description thereof will be omitted.

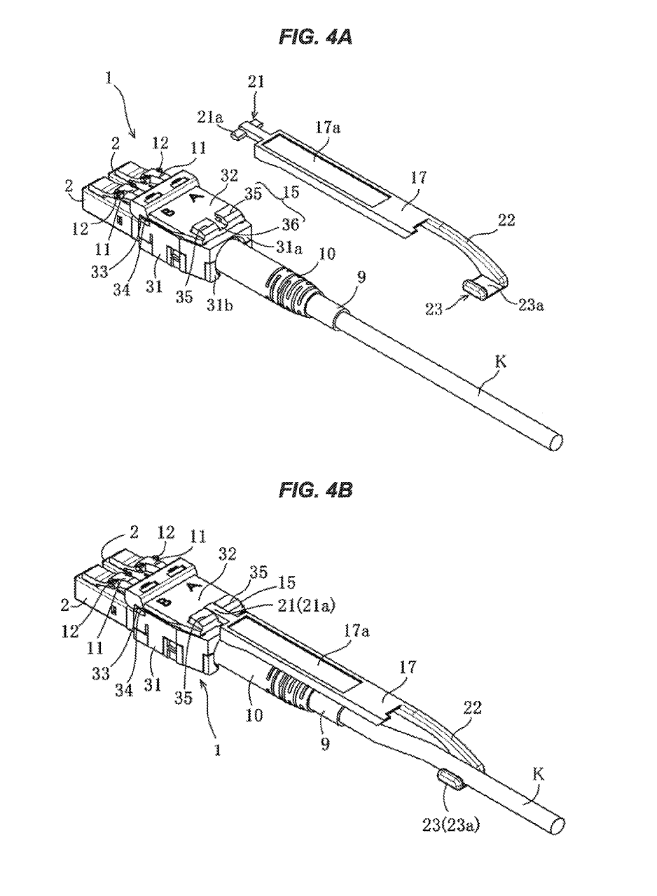

As shown in FIG. 4B, a plug main body 1 constructing an LC type double core optical connector plug is provided with a retention body 31 which retains a pair of right and left coupling sleeves 2, accommodates a pair of right and left optical fiber core wires F extending rearward from the coupling sleeve 2 and is formed into a rectangular casing, and protects by a boot 10 one optical cord K which simultaneously accommodates a pair of optical fiber core wires F extending from the retention body 31. Further, a slider 32 having a flat plate shape is provided in an upper surface of the retention body 31 so as to be slidable in a back-and-forth direction.

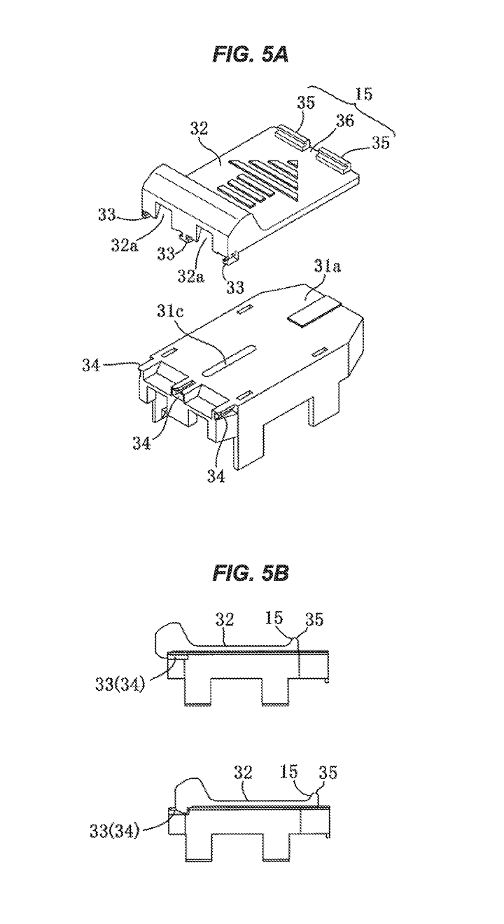

As shown in FIGS. 4A, 4B, 5A and 5B, the retention body 31 is provided with an upper holder portion 31a and a lower holder portion 31b which are divided into two sections up and down, and is constructed by combining the both from a vertical direction. Further, a guide long hole 31c is formed in the back-and-forth direction at the center of the upper holder portion 31a, and a leg portion (not shown) which is provided in a lower portion of the slider 32 is fitted to and inserted into the guide long hole 31c, whereby the slider 32 slides in the back-and-forth direction.

Further, as shown in FIG. 5A, in a lower edge portion of a front end side of the slider 32, engagement projections 33 each having an approximately L-shaped form are provided in both right and left ends and the center so as to protrude toward the opening portions 32a, and engagement concave portions 34 each having an approximately C-shaped long groove form are provided in a protruding manner in an upper edge portion of the front end side of an upper holder portion 31a in correspondence to the engagement projections 33. The engagement projections 33 are structured, as shown in FIG. 5B, such as to be fitted to the engagement concave portions 34 from a forward side toward a rear side. Thereafter, the engagement projections 33 get out from the rear side to the front side.

A front end side of the upper surface of the slider 32 is upraised somewhat forward diagonally, the opening portions 32a having the approximately C-shaped arch form are provided to pass through in the back-and-forth direction so as to form a space where a pair of release levers 11 can displace in a direction which is approximately perpendicular to the axial direction, in an upper side where an inner side of the upraised portion faces to the retention body 31, and right and left symmetrical portions in the inner side of the opening portions 32a form the taper surface 32b which are inclined toward the leading end side of the retention body 31. A pair of right and left release pieces 11a in the inclined rear end portion of the release lever 11 are engaged with the taper surfaces 32b. When the plug main body 1 is installed to the adapter 50, the plug main body 1 and the adapter 50 are engaged by the locking piece 12 of the release lever 11 in the same manner as the case of the present embodiment mentioned above.

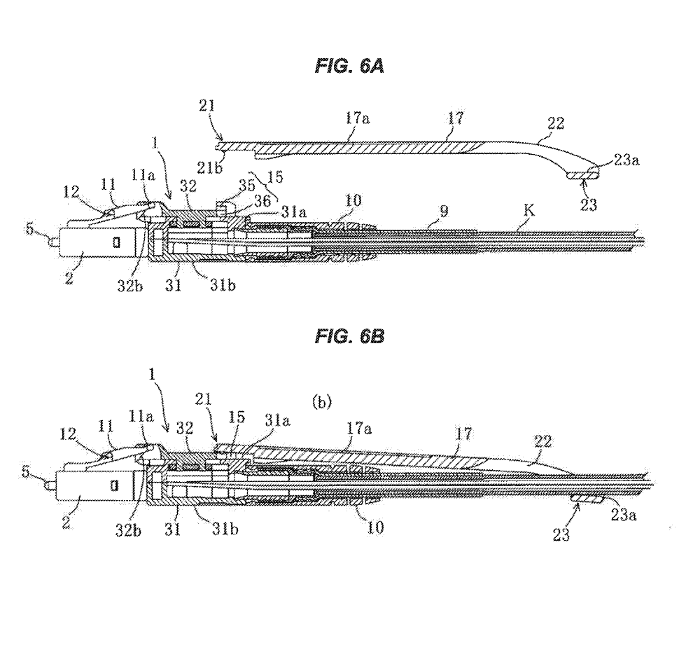

Further, a pair of right and left locking concave portions 35 are provided in a rear end of the upper surface of the slider 32. A slit portion 36 is formed between a pair of right and left locking concave portions 35, and inner surfaces of the locking concave portions 35 are opened toward inner sides via the slit portion 36. As shown in FIGS. 4A, 5A and 6A, the retainer mechanism 21 according to the present example is formed to be a protruding piece portion 21a which is provided in the tab leading end of the pull-out tab 17 for engaging over a pair of right and left locking concave portions 35 and is formed into a T-shaped form in a plan view. Further, when the pull-out tab 17 is attached to the slider 32, both ends of the T-shaped portion of the protruding piece portion 21a are engaged over a pair of right and left locking concave portions 35, and the center of the T-shaped portion is engaged with the slit portion 36.

Meanwhile, the grip portion 22 curved downward is extended from one end side surface of the rear end of the pull-out tab 17, and a catch portion 23a is formed in the last end of the grip portion 22, the catch portion 23a constructing the support portion 23 for mounting the optical cord K and formed into a transversely L-shaped form (an approximately C-shaped form or an approximately U-shaped form in a front view).

As a result, when the LC type double core plug main body 1 is simultaneously pulled out of the adapter 50, the slider 32 is moved in the same pull-out direction in an interlocking manner by moving the grip portion 22 of the pull-out tab 17 in the pull-out direction with the fingertip. At this time, since the release pieces 11a in the rear end portions of the right and left release levers 11 are simultaneously pushed down by the taper surfaces 32b of the slider 32, the engagement between the locking piece 12 of each of the right and left release levers 11 and the adapter 50 is released in the same manner as mentioned above. Further, in the case that the slider 32 moves in the pull-out direction while holding the grip portion 22, the engagement projection 33 and the engagement concave portion 34 collide and stop each other so as to be controlled, so that the plug main body 1 can be pulled out of the adapter 50. As described above, in the present example, it is possible to prevent the other adjacent pull-out tab 17 from entering into and intertwining in the portion between the pull-out tab 17 and the optical cord K.

<Structure of Pull-Out Tab of MPO Type Optical Connector Plug>

Next, a description will be given of a specific structure of a pull-out tab which is a feature of the present invention on the assumption that an optical connector plug according to an MPO type push-pull system is a basic structure.

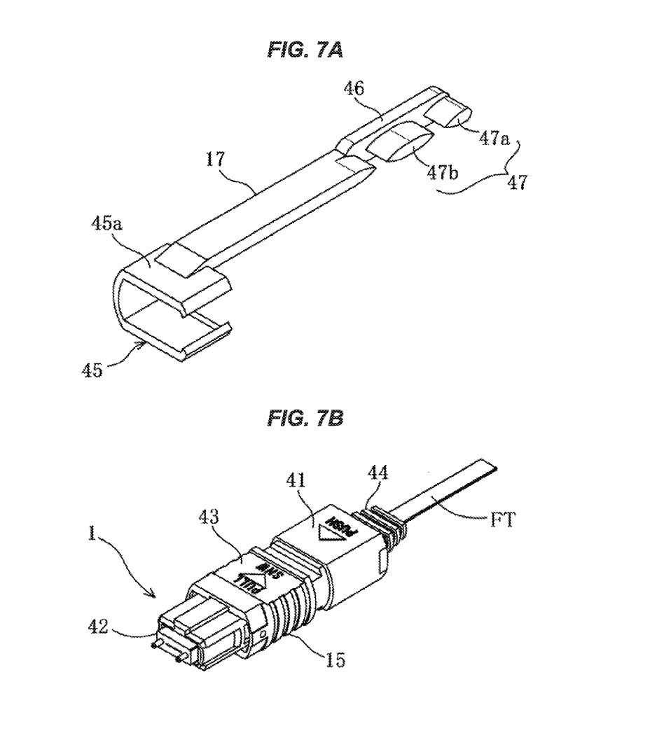

A plug main body 1 constructing an MPO type optical connector plug, as shown in FIG. 7B, accommodates a ferrule 42 which is attached to a leading end of an optical fiber tape core wire FT, in a leading end (a front end) of a housing 41 with the sleeve shape. A spring (not shown) elastically energizing the ferrule 42 to a front side of the plug main body 1 is provided within the housing 41. Further, the plug main body 1 has a coupling 43 with the tubular shape which is outward inserted into the housing 41 and is provided so as to be slidable in a movable range which is secured in an axial direction in relation to the housing 41, and a boot 44 which is attached to a rear end portion which is opposite to the front end provided with the ferrule 42 of the housing 41.

The plug main body 1 is inserted into the adapter 50 by the worker pressing a portion positioned in the rear side from the coupling 43 in the plug main body 1, for example, the housing 41 toward the adapter 50 with a finger. Further, the plug main body 1 is pulled out of the adapter 50 by pulling in the coupling 43 to the housing 41 side.

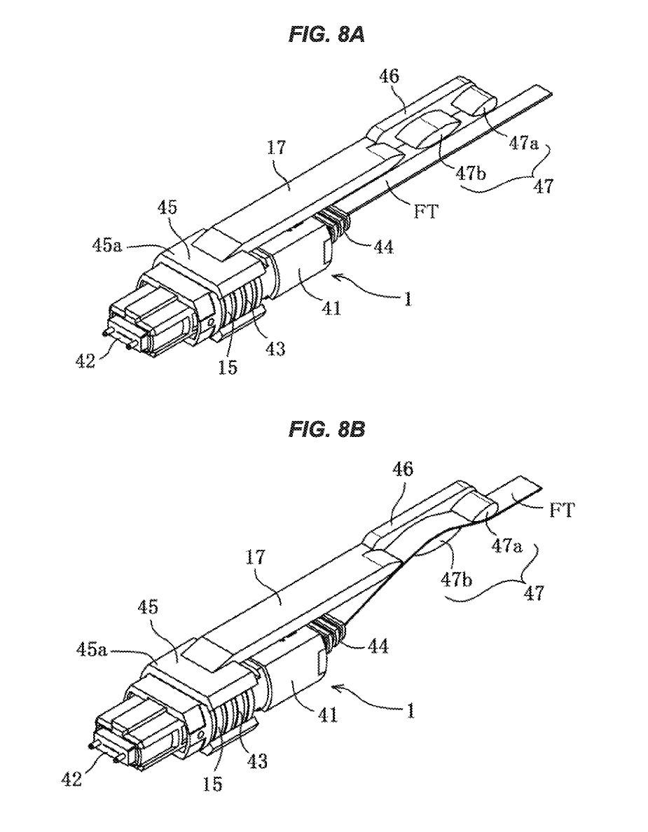

As shown in FIGS. 7A, 8A and 8B, a pull-out tab 17 which can operate the coupling 43 in the rearward optical fiber taper core wire FT side is detachably installed to the coupling 43 which is used as the operation portion 15. The pull-out tab 17 is provided with a retainer mechanism 45 constructed by a transversely C-shaped frame 45a which is provided in the tab leading end of the pull-out tab 17 (in which one side surface of the transversely C-shaped frame is fixed to the tab leading end), and a grip portion 46 with the tabular shape which is extended vertically from one side in the tab rear side of the pull-out tab 17, for engaging with the coupling 43 from side directions. A rear projection 47a having an approximately spindle shape in its cross section is provided to be protruded transversely in the last end of the side surface of the grip portion 46, and an intermediate projection 47b having an approximately oval shape in its cross section is provided to be transversely protruded approximately at the center of the side surface of the grip portion 46. As a result, a support portion 47 is provided by the rear projection 47a and the intermediate projection 47b, the support portion 47 being structured such as to alternately catch over up and down the optical fiber core wire FT to be slidable and be capable of gripping the optical fiber taper core wire FT.

As a result, when the plug main body 1 is pulled out of the adapter 50, the coupling 43 is moved in the same pull-out direction in an interlocking manner by moving the grip portion 46 positioned in the optical fiber tape core wire FT side of the pull-out tab 17 in the pull-out direction with the fingertip, and the plug main body 1 is released from the adapter 50. As described above, in the present example, it is possible to previously prevent the other adjacent pull-out tab 17 from entering into and intertwining in the portion between the pull-out tab 17 and the optical fiber taper core wire FT.

1. A pull-out tab of an optical connector plug structured such that the optical connector plug is engaged with and disengaged from an adapter by the pull-out tab which is detachably installed to an operation portion of the optical connector plug,
wherein said pull-out tab is provided with a retainer mechanism which is arranged in a tab leading end for installing to the operation portion of said optical connector plug, and a support portion which is arranged in the last end of the tab for gripping an optical cord.

2. The pull-out tab of the optical connector plug according to claim 1, wherein said retainer mechanism is formed by a set hole which is provided in a tab leading end for installing to an operation portion of an LC type single core optical connector plug, and said support portion is formed as a downward C-ring shaped hook in the last end of a lower surface of a grip portion which is extended to a rear side of the tab for gripping the optical cord.

3. The pull-out tab of the optical connector plug according to claim 1, wherein said retainer mechanism is formed as a pair of set holes which are provided in a tab leading end for respectively installing to a pair of operation portions of a pair of LC type single core optical connector plugs, and said support portion is formed as an approximately ring shaped hook in the last end of a lower surface of a grip portion which is extended to a rear side of the tab for gripping a pair of optical cords.

4. The pull-out tab of the optical connector plug according to claim 1, wherein said retainer mechanism is formed as a protruding piece portion which is formed into a T-shaped form in a plan view and is provided in a tab leading end for installing over a pair of right and left locking concave portions of an LC type double core optical connector plug, and said support portion is formed as a transversely L-shaped catch portion in the last end of a side surface of a grip portion which is extended to a rear side of the tab for mounting the optical cord.

5. The pull-out tab of the optical connector plug according to claim 1, wherein said retainer mechanism is provided with a transversely C-shaped frame which is arranged in a tab leading end for installing to a coupling which constructs an operation portion of an optical connector plug according to an MPO type push-pull system from a lateral side, and a support portion which catches an optical fiber tape core wire alternately up and down by a rear projection which is protruded transversely in the last end of a side surface of a grip portion which is extended to a rear side of the tab and an intermediate projection which is protruded transversely at the midpoint of a side surface of the grip portion so as to be slidable and be capable of gripping.
